(19) United States
(12) Patent Application Publication
(10) Pub. No.: US 2025/0125103 A1
(43) Pub. Date: Apr. 17, 2025

(54) AIR COOLED DISCONNECTOR PROVIDED WITH COOLING SLOTS

(71) Applicant: GE Infrastructure Technology LLC, Greenville, SC (US)

(72) Inventor: Christoph MULLER, Villeurbanne (FR)

(73) Assignee: GE Infrastructure Technology LLC, Greenville, SC (US)

(21) Appl. No.: 18/917,177

(22) Filed: Oct. 16, 2024

(30) Foreign Application Priority Data
Oct. 16, 2023 (EP) 23203719.2

(51) Int. Cl. H01H 9/52; H01H 71/02

(52) U.S. Cl. CPC H01H 9/52; H01H 71/025; H01H 2009/526

(57) ABSTRACT

A high voltage circuit breaker and disconnector for operation in air, extending along an axis, including an enclosure, the disconnector including a hollow current carrying conductor in the enclosure and extending along the axis. The conductor including at least one lower elongated slot and at least one upper elongated slot extending along the axis, each of the slots having a width w and a length l opening an air flow cross section. The ratio between the outer diameter surface of the hollow current carrying conductor and the total air flow cross section of all the slots in a same plane perpendicular to the axis being between 70 and 100.

### TECHNICAL FIELD

The invention relates to the field of air cooled disconnectors for generator circuit breakers.

### BACKGROUND

A generator circuit breaker and the corresponding disconnector operates in air and is contained in a closed casing.

Cooling of such devices is important as the high current coming from the power plant generator running over generator circuit breaker and its attached disconnector is creating huge amounts of heat. This heat must be transferred efficiently to the outside to limit the temperature of live parts to standardized limits. To strengthen the heat transfer several methods are used such as:
heat carrying fluids moving hot to the outside cooling down and coming back cold to the inside;
fans which are blowing the air inside the enclosure and increasing the heat exchange between cold enclosure and hot live parts;
natural convection carrying calories via natural fluid movement from the hot live parts to the cold enclosure.

Natural cooling was fostered by putting cooling fins and cooling holes. The cooling holes were positioned at several locations all around the disconnector. They had oval, circular, triangular and rectangular shapes. Such solutions were dimensioned, positioned and shaped by trial and error. Like other solutions of the prior art, this method does not considered the 3D effects of air circulation, skin and proximity effect and temperature dependant resistivity. By doing so, prior art designs cause current concentration close to cooling holes and/or stagnation zones with no air movement leading finally to unwanted local hot spots.

Knowing the vicious circle of higher temperature leading to increased resistivity leading to even higher losses and thus even higher temperatures, these hot spots are a serious risk for the overall performance of the equipment.

The maximum nominal current of the equipment is the current not leading to a higher temperature than the maximum temperature of the apparatus which is the hot spot. Thus, the hottest spot is limiting the nominal current and not the overall design. For constructors it is of clear interest to strengthen the design to prevent hot spots.

Furthermore, the designs of the prior art often found by trial and error are not reliable as it is impossible to capture all hot spots with a limited amount of temperature sensors.

In particular, designs of prior art do not consider the effect of the air circulation, which can be locally reduced to zero in a stagnation zone nor the possible concentration of current at locations close to the holes resulting in higher current densities and in further Joule heating at said locations.

There is a need for a more efficient solution, both for the disconnector and for the enclosure.

### SUMMARY

The invention first concerns an optimized design of cooling slots in hollow current carrying conductors for an air cooled disconnector.

The invention concerns in particular a disconnector for a high voltage circuit breaker, or a high voltage circuit breaker and disconnector, extending along an axis (XX′) (or axial direction), said disconnector comprising an enclosure and a hollow current carrying conductor in said enclosure, said conductor comprising at least one lower elongated slot and at least one upper elongated slot extending along said axis.

Said disconnector can comprise a female part, a tube housing and a moveable tube to connect said female part and said tube housing; said slots can be provided to any of said parts, for example to only one (for example the tube housing) or to 2 or to all 3 of them.

The invention also concerns a method for cooling a disconnector or circuit breaker and disconnector operating in air, extending along an axis (XX′), said disconnector comprising an enclosure and a hollow current carrying conductor in said enclosure, said conductor comprising at least one lower slot and at least one upper slot extending along said axis, a current of, for example, between 10 kA and 30 kA or even up to 50 kA, circulating in said conductor, whereby air is circulating from said least one lower slot to said at least one upper slot.

In a high voltage disconnector or circuit breaker and disconnector according to the invention or in a method according to the invention, each of said slot may have a width between 5 mm and 40 mm, for example 8 mm or 10 mm or 20 mm or 30 mm, said width being measured perpendicularly to said axis (XX′) or in a plane perpendicular to said axis (XX′).

Preferably, the maximum nominal current is in a range of 10 kA to 50 kA, for example 30 kA, depending on the configuration of the equipment. The current during operation of the power plant may therefore be set from 0 kA to the maximum nominal current.

The invention concerns the cooling of a hollow disconnector, for example of the type being attached to or beneath a high voltage generator circuit breaker. The disconnector according to an aspect of the invention is operated, insulated and cooled in ambient air. To increase its performance a natural cooling method is implemented, which does not require expensive cooling fans or cooling circuits using cooling liquid.

Thus, the invention also concerns a method for air cooling a generator circuit breaker's disconnector comprising an inner hollow portion or a hollow conductor, extending along an axis (XX′) (or axial direction), comprising circulating air through the at least one bottom slot, then through said hollow portion inside of the disconnector or through said hollow conductor and through the at least one upper slot.

For example, the invention concerns a cooling method of a generator circuit breaker's disconnector operating in air, said disconnector comprising an inner hollow portion or a hollow conductor, said method comprising:
circulating cool air through one bottom slot, preferably located at, or close to, the lowest possible position of said conductor, then heating up inside the hollow conductor or the hollow live conductor, the hot air leaving at one top slot, preferably located at, or close to, the highest possible position of said conductor; the motor of this natural circulation is the temperature dependency of the air density leading with gravity to an upwards movement of hot air;
or circulating cool air through two or more bottom slots, preferably located at, or close to, the lowest possible position of said conductor, then heating up inside the hollow conductor or hollow live conductor, the hot air leaving at two or more top slots, preferably located at, or close to, the highest possible position of said conductor.

In both cases, the motor of the natural circulation is the temperature dependency of the air density leading with gravity to an upwards movement of hot air.

In a device or a method according to the invention, an air cooled disconnector is implemented, comprising a hollow current carrying conductor, extending along an axis (XX′) (or axial direction), provided with at least two cooling slots, elongated along said axis or along a direction parallel to said axis, preferably opposed to each other or facing each other, or for example 2 pairs of cooling slots, preferably opposed to each other or facing each other.

Thus, air can flow from the coldest area at the bottom of the enclosure via the bottom slots in the hollow conductor, heats up inside and becomes lighter and then moves through the top slots out of the conductor and then to the ceiling of the enclosure. At the ceiling of the enclosure the hot air of the hollow conductor cools down and moves to the enclosure left and right side and finally cools, becomes heavier with a density increase and drops to the bottom of the enclosure. Then the circular movement can start again.

The invention allows a more efficient natural cooling of the conductor while saving conductive material.

According to various embodiments of a device or a method according to the invention:
the slot(s) preferably has/have a long linear shape, each of said slot may have a length between 20 mm and 400 mm, for example 40 mm or 60 mm or 80 mm or 200 mm, said length being measured along, or along a direction or an axis parallel to, said axial direction;
and/or any of the slot(s) of the top and/or bottom slot(s) can be divided into several aligned slots to increase the mechanical strength of the hollow conductor;
and/or there are 2 slots at the top and 2 at the bottom of the hollow conductor, the spacing between each pair of cooling slots being for example between 10° and 80°, for example 10° or 30° or 70°;
and/or said hollow current carrying conductor has an outer diameter of between 30 cm and 200 cm;
and/or the number of slots at the top and/or at the bottom of the device is at least equal to 1, or 2, or 3, or 4 or to n (n<10); for example said conductor comprises at least 1, 2, 3 or more lower slot(s) and a same or a different (for example for mechanical reasons) number of upper slot(s), said lower slot(s) and upper slot(s) preferably facing each other;—and/or the ratio between the disconnector's heat exchange surface on the outside diameter, for instance 180.000 mm2, of said hollow current carrying conductor and the sum of air flow cross sections of all upper and all lower slots, for instance 2400 mm2, should preferably be comprised in the range of 70 to 100. Outside this range, cooling slots are less efficient as they either require removing too much of the conductive material (which leads to higher current densities and thus higher Joule losses and in the following higher temperatures) or they are too small (very small slots impede the natural cooling air circulation, resulting in an ineffective cooling and thus in higher temperatures).

The air flow cross sections of the slots are parallel to XX′ of the disconnector.

Preferably at least one of the slots have rounded ends at the inside of the conductor, which is favorable to the fluid flow along the inside of the conductor. Knowing that the skin effect concentrates the current at the outside of the conductor, such a rounded shape should be implemented preferably only at the inside or inner surface of the conductor where an electrical cross section reduction is of less importance.

In the axial direction (XX′), one or more (preferably all) of the cooling slots preferably has at least one rounded or oval end, which enables the current to flow smoothly around said rounded or oval shaped end without creating current concentrations. Preferably, the two ends of said one or more, or of all, slot(s) are rounded or oval.

According to the invention, different sets of slots may be implemented. Parameters like width and/or length and/or shape and/or design, and/or the number of slots and/or the radial distribution of slots can be varied. Depending on the needs, a trade-off is recommended taking into account that, with the introduction of bigger or larger slots:
the electrical current cross section is reduced; the presence of the cooling slots decreases the available current cross section and raises the current density in the remaining conductor leading to higher joule losses and consequently a higher temperature;
natural convection gets more powerful as the air can travel more easily through wider bottom and top slot(s); the pressure drop for wider slots or openings is lower and a higher mass flow of cold air can go into the hollow disconnector and cool it consequently more efficiently from the inside.

### BRIEF DESCRIPTION OF THE DRAWINGS

FIGS. 1 and 2 show an example of a generator circuit breaker with its disconnector to which the invention can apply;

FIGS. 3A and 3B show an example of a disconnector with its different parts according to the invention;

FIGS. 4A and 4B show an embodiment of the invention including double slots (FIG. 4A) and triple slots (FIG. 4B);

FIGS. 5A and 5B show a simplified model of a disconnector according to the invention, comprising a single slot at the bottom and a single slot at the top;

FIGS. 5C, 5D and 5E give calculation results of the simplified model shown in 5A and 5B, FIG. 5C showing a temperature map; FIG. 5D showing a cooling air velocity map and FIG. 5E showing a current density map of a device according to the invention;

FIGS. 6A and 6B show a simplified model of an embodiment of a disconnector according to the invention, comprising 3 slots at the bottom and 3 slots at the top;

FIGS. 6C, 6D and 6E give calculation results of the simplified model shown in 6A and 6B, FIG. 6C showing a temperature map, FIG. 6D showing a cooling air velocity map and FIG. 6E showing a current density map of a device according to the invention;

FIG. 7A shows results (in terms of temperature rise) for different slot widths w (measured in a radial cross section of the disconnector) for a configuration having one top slot and one bottom slot;

FIG. 7B shows results (in terms of temperature rise) for different number of top and bottom slots;

FIG. 7C shows results (in terms of temperature rise) for different angles between slots (measured in a radial cross section of the disconnector);

FIGS. 8A and 8B show views, in a radial cross section of the disconnector, of a preferred shape of a single top slot and a single bottom slot;

FIGS. 9A and 9B show views, in a radial cross section of the disconnector, of a preferred shape of a design comprising two top slots and two bottom slots;

FIG. 10A-10E show a top view or a bottom view of preferred shapes of one or more upper slots;

FIG. 11 shows the natural cooling flow through a disconnector according to an embodiment of the invention and comprising upper and lower slots oriented with respect to the vertical direction.

### DETAILED DESCRIPTION

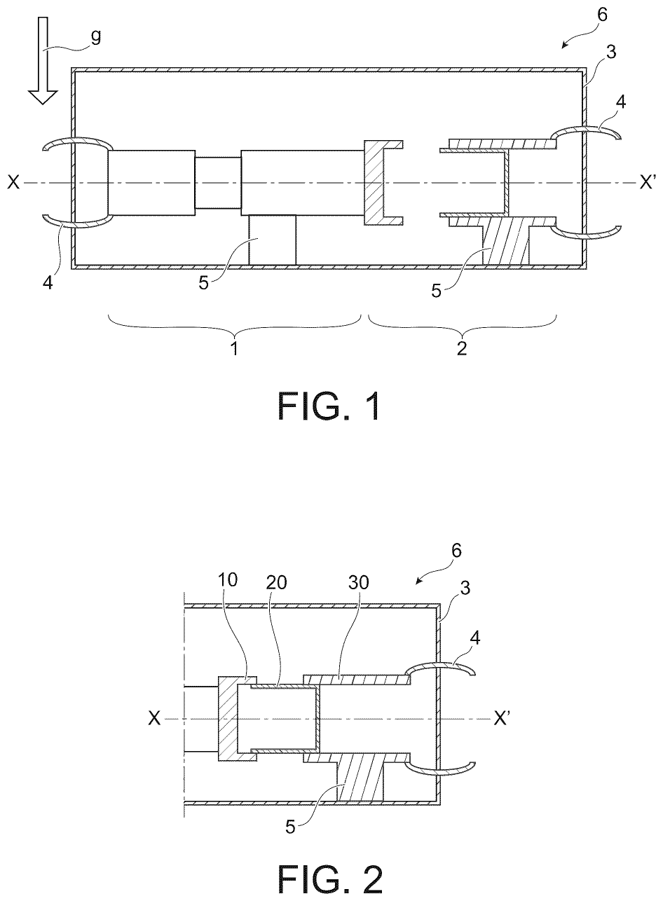

The structure of a device to which the invention can apply is shown on FIGS. 1 and 2.

It comprises a generator circuit breaker 1 (which can be connected via braids 4 to a busbar, which is itself can be linked to a generator) and a disconnector 2 (which can be connected via braids 4 to a busbar which itself can be linked to a transformer, for example a step-up transformer), both extending along an axis XX′. The outer diameter of the disconnector's tube housing 30 depends on the rated current and can vary for example from 30 cm to 200 cm.

Both the generator circuit breaker 1 and the disconnector 2 can be supported by an insulator 5 separating central live parts from a grounded casing or enclosure 6.

The disconnector 2 can comprise 3 main parts as illustrated on FIG. 2. This hollow air cooled and insulated disconnector has an outer diameter which is for example between 30 cm and 200 cm (outer diameter of the tube housing 30) depending on its performance. It can comprise a female part 10 which can be thoroughly and preferably permanently connected to the generator circuit breaker 1, a moveable tube 20 and the tube housing 30. Usually both parts 10 and 30 have almost the same outside diameter. The movable tube 20 can connect, via an axial movement along the axis (XX′), the generator with the transformer. In other words, the hollow movable tube 20 opens and closes the contact with the other fixed side 30 (the tube housing). The whole device can also comprise an earthing switch, a generator starting switch, current and voltage transformers, and a surge arrestor, which are not shown on the figures. The device is in a casing or enclosure 3 which is filled with air. The casing 3 cannot exchange air with the outside atmosphere 6; it protects the current carrying part (busbar, braids, circuit breaker, disconnector) from the environment, keeps the magnetic field inside and protects from unwanted grounding of live parts.

A current, or a nominal current, of between 10 kA and 30 kA or even up to 50 kA can flow in said disconnector. The nominal current is the maximum current that can flow through the device. A current above the nominal current may result in overheating and may destroy the apparatus. In operation, the current flowing over the circuit breaker and disconnector varies from 0 kA to the nominal current, for example 30 kA.

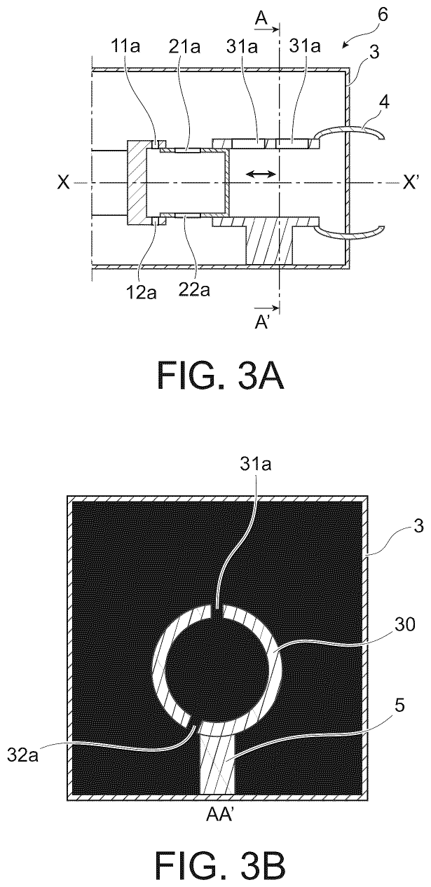

According to an example of a disconnector according to the invention, illustrated on FIGS. 3A and 3B, one or more cooling slot(s) 11a, 21a and 31a is/are located at the top and one or more cooling slot(s) 12a, 22a and 32a is/are located at the bottom of the disconnector, more precisely of at least one of the parts 10, 20, 30 of said disconnector as explained above. As it can be seen on FIG. 3A such cooling slots can be present on all 3 parts 10, 20 and 30.

The rest of this description is focused on slots made in the tube housing 30 but may apply as well to slots possibly made in the other parts 10, 20.

Preferably, the cooling slots 32a at the bottom of the part 30 are next to the insulator 5.

Each slot is preferably extending along (or parallel to) the axis XX′. The effect of such slots are discussed below. In this application, the “top” (or the “upper”) and the “bottom” (or the “lower”) parts of the conductor have to be understood with reference to the direction of gravity g (as illustrated on FIGS. 1 and 11).

FIG. 3B shows a cross section of the tube housing 30. Due to the presence of the insulator 5, the bottom slots 32a and the top slots 31a are slightly offset from each other.

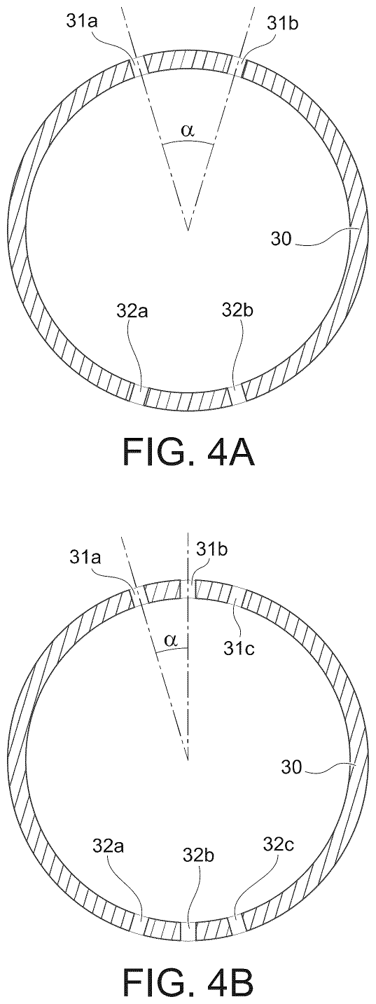

FIGS. 4A and 4B show a device according to the invention, comprising 2 bottom slots and 2 upper slots (FIG. 4A) and 3 bottom slots and 3 upper slots (FIG. 4B). The angle α is the angular spacing between parallel slots, measured in a plane perpendicular to axis XX′ (or in a radial cross section of the disconnector).

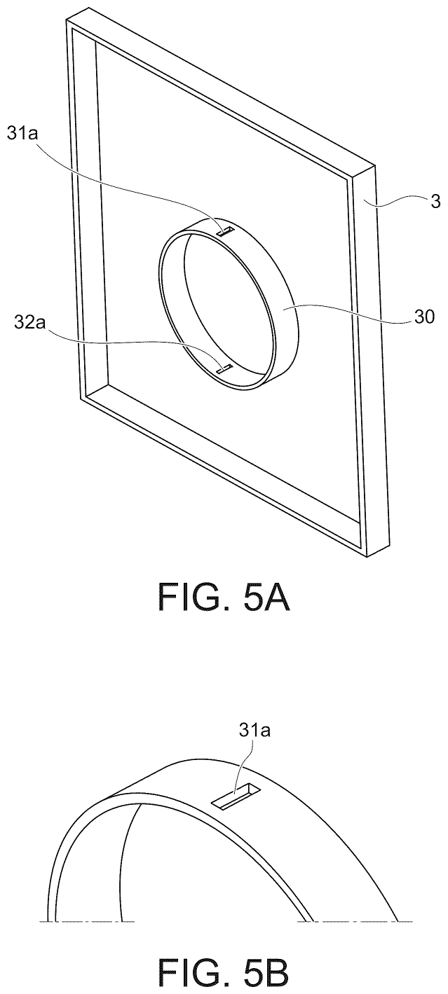

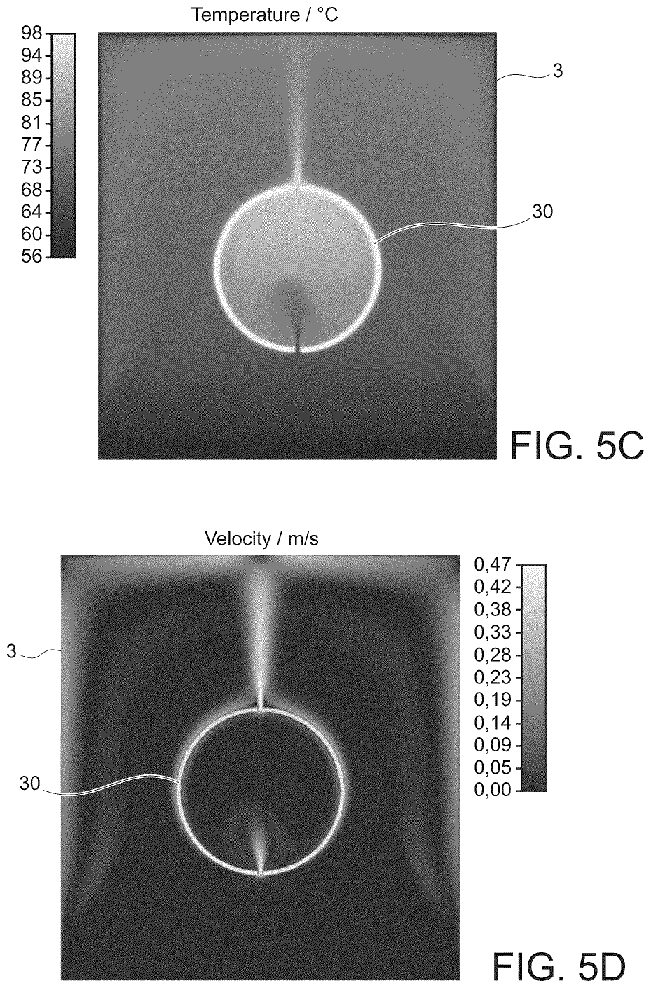

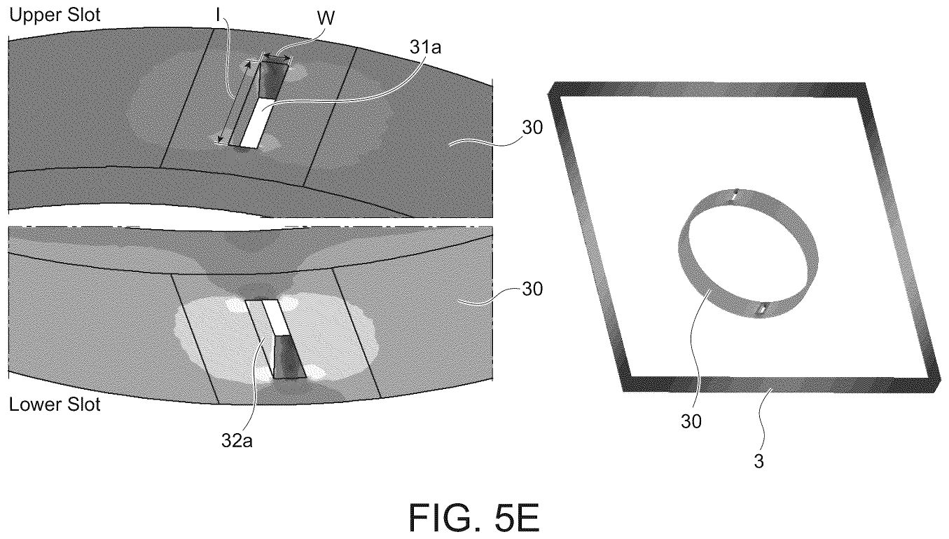

In view of different computer simulations which were performed for a disconnector according to the invention and which are presented below, a simplified model an embodiment of a disconnector 2 and its casing 3 were used, as illustrated on FIGS. 5A and 5B: said embodiment comprises a ring or a hollow tube which corresponds to the disconnector's hollow tube housing 30 in a frame which corresponds to the casing 3 (having for example a thickness the of 12 mm). In all simulations, symmetric boundary conditions were chosen.

Simulation results of the model of the embodiment of FIGS. 5A and 5B are illustrated on FIGS. 5C, 5D (both FIGS. 5C and 5D including the temperature and speed scales) and 5E: FIG. 5C shows the temperature distribution, FIG. 5D gives the air speed distribution and FIG. 5E gives the current density nearby the slots (the current density being higher just around the slots). The simulated model comprises one cooling slot 31a at the top of the disconnector and one cooling slot 32a at the bottom of the disconnector.

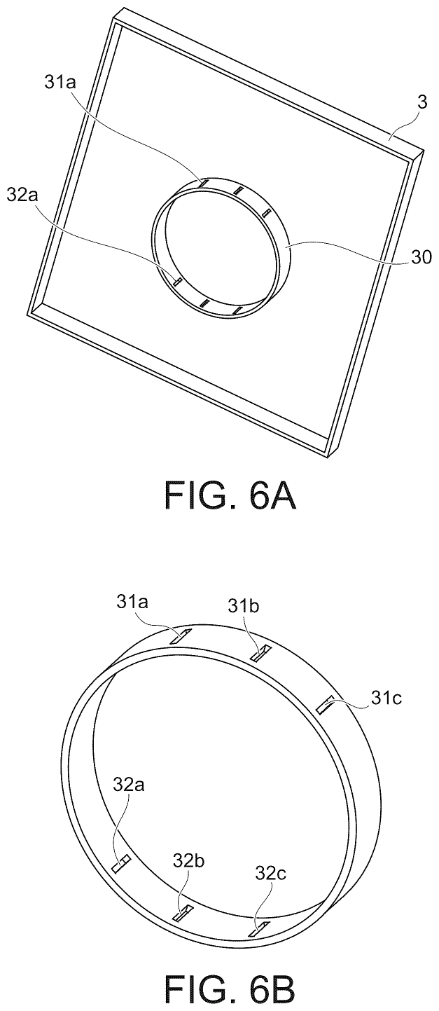

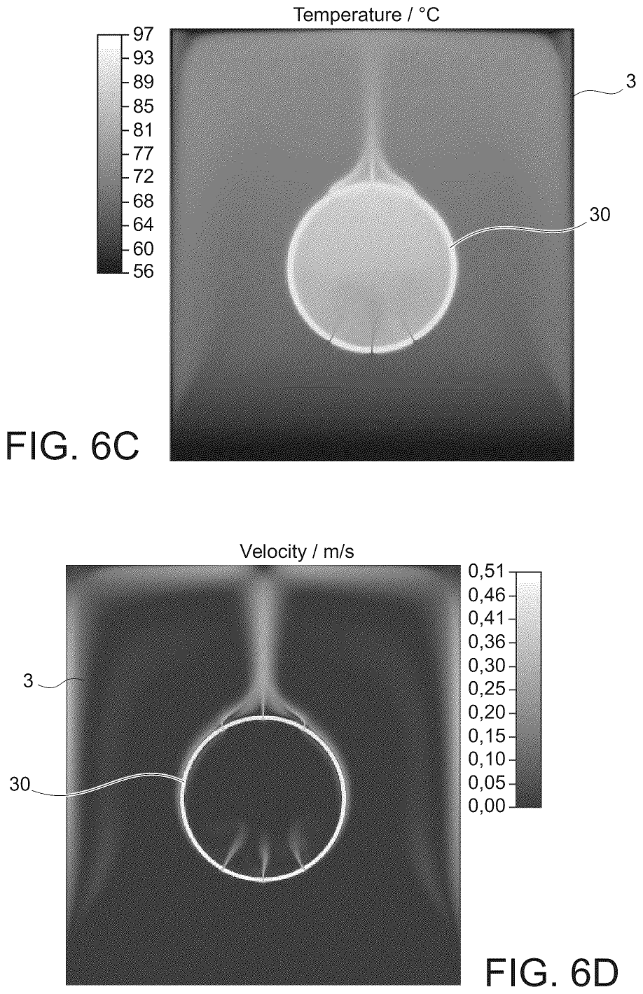

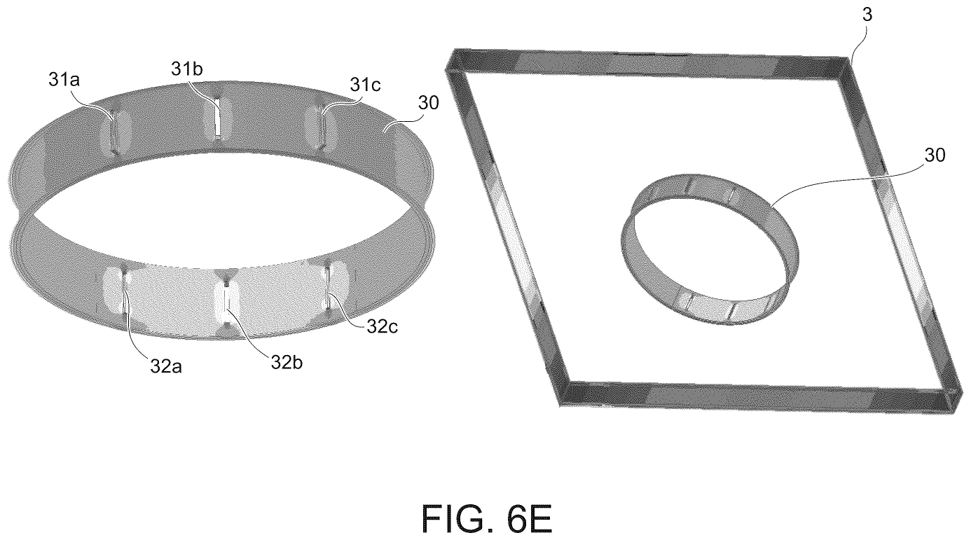

Another simplified model of a disconnector 2 according to an embodiment of the invention is shown on FIGS. 6A and 6B, said embodiment comprising 3 cooling slots 31a, 31b and 31c at the top of the disconnector and 3 cooling slots 32a, 32b and 32c at the bottom of the disconnector. The simulation results for that other simplified model are illustrated on FIGS. 6C, 6D and 6E: FIG. 6C gives the temperature distribution, in particular nearby the slots, FIG. 6D shows the air speed distribution and FIG. 6E shows the current density nearby the top and bottom slots.

Whatever the number of top cooling slots 31a and or 31b and or 31c and bottom cooling slots 32a and or 32b and or 32c, their position can be an optimal trade-off between:
the reduction, due of the presence of the slots 31a to 31c and 32a to 32c, of the cross section for the current (said reduction generating more heat due to higher current density and thus higher Joule effect around the slots);
and the more efficient natural cooling by convection; but more cooling of the conductor 30 takes away and transports more heat which, in turn, will heat the enclosure 3.

Furthermore:
a better cooling may result in more heat being transported by the gas close to the enclosure, which may in turn be heated;
and/or more Joule heating close to the cooling slots results in more heat being dissipated which, again, may heat the enclosure.

A disconnector according to the invention can have, for example:
only 1 cooling slot 31a at the top of the disconnector and 2 cooling slots 32a and 32b at the bottom;
2 cooling slots 31a and 31b at the top of the disconnector and only 1 cooling slot 32a at the bottom;
only 1 cooling slot 31a at the top of the disconnector and only 1 cooling slot 32a at the bottom (as illustrated on FIGS. 5A and 5B).
3 cooling slots 31a, 31b and 31c at the top of the disconnector and 3 cooling slots 32a, 32b and 32c at the bottom (as illustrated on FIGS. 4B, 6A and 6B).
several top cooling slots and several bottom cooling slots, the number of top and bottom cooling slots can be identical or not; for example, it is possible to have, for mechanical reasons, 2 slots (each having for example a width w=10 mm) at the top and 3 slots (each having for example a width w=6.67 mm) at the bottom (for mechanical reasons).

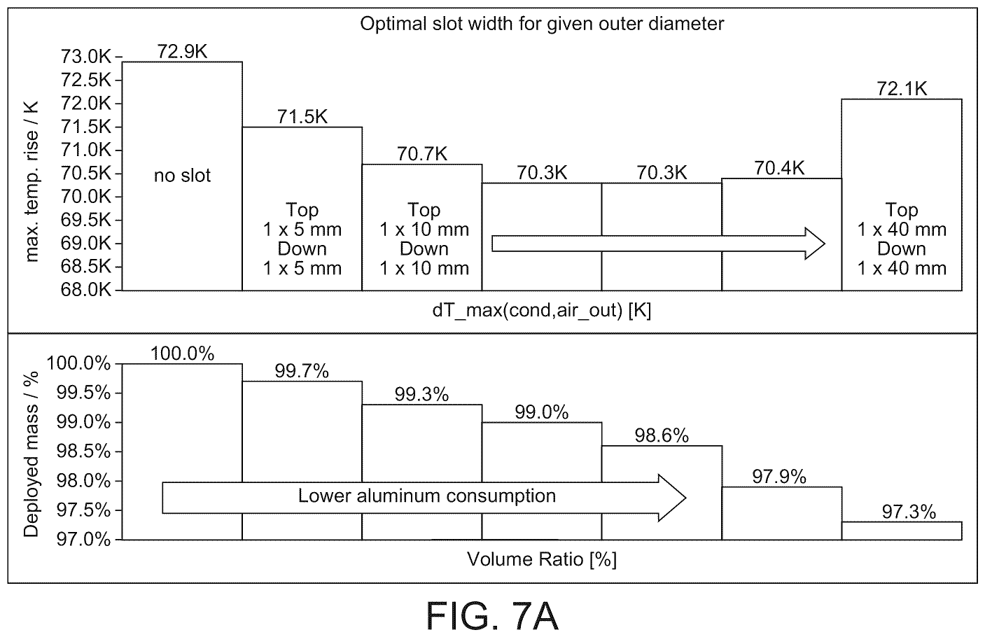

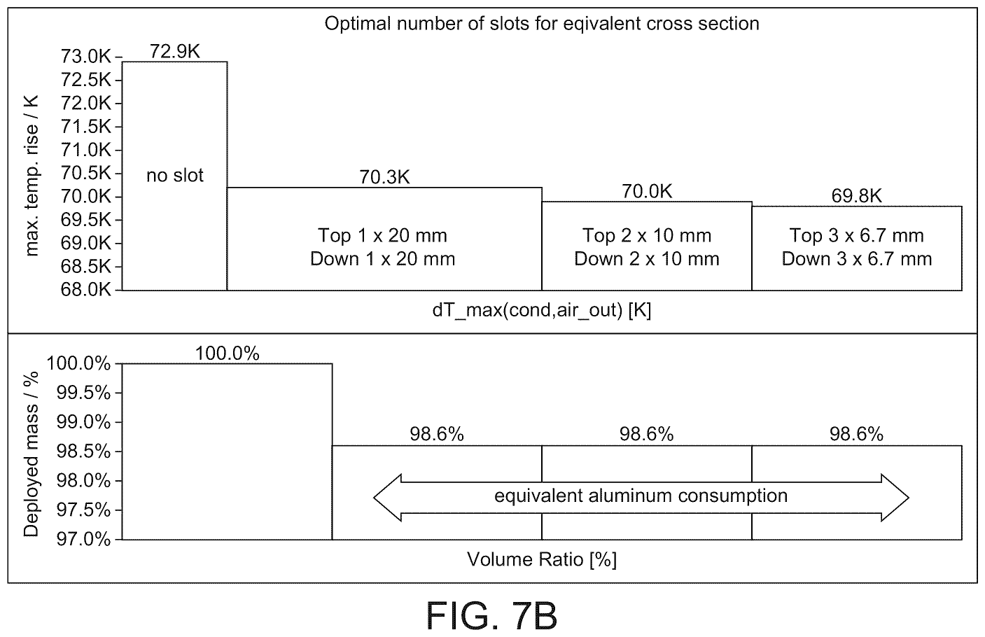

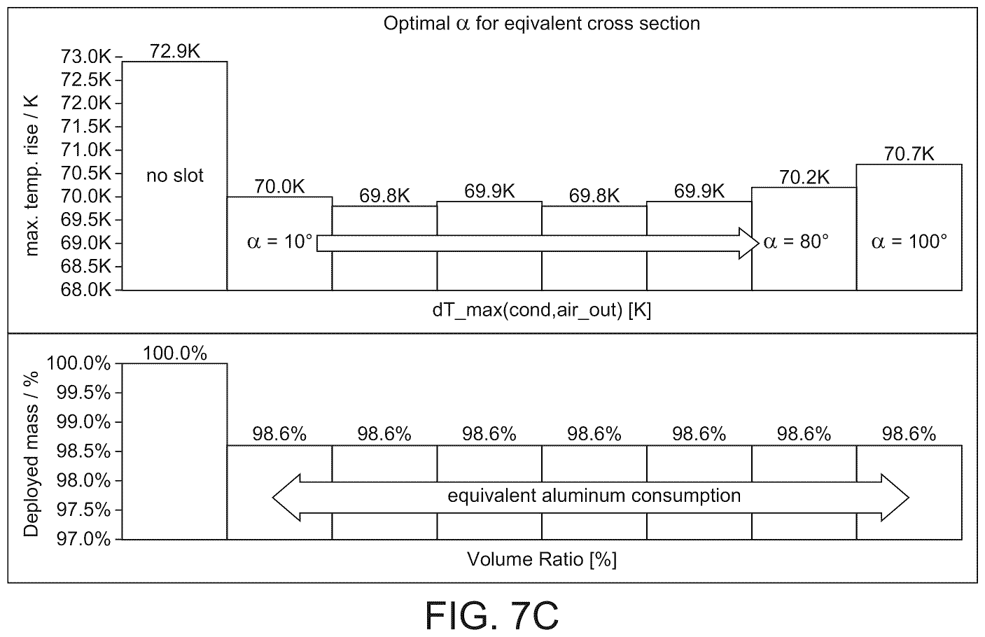

The slots according to the invention save between 1% and 3% of conductive material (see bottom part of each of FIGS. 7A, 7B-7C, commented below), making the conductor 30 (or the corresponding part of the disconnector) lighter.

More generally each slot can have a width w (see FIG. 5E) between 0.2 cm and 4 cm, for example 1 cm, measured perpendicularly to the axis (XX′) (see FIG. 7A).

The ratio between the outer diameter surface of said hollow current carrying conductor 30 and the added slot cross section which is width w×length l×the number (see FIG. 5E) of all slots (31a and 32a) is preferably between 70 and 100, more preferably between 80 and 90, more preferably equal to, or close to, 85. A ratio outside the range 70-100 is not favourable for optimal results (a higher temperature rise is generated if the ratio is in the range 70-100).

Best results are obtained if the surface of all lower slots through which the air flows is equal or similar (in a range of +10%, preferably +5%) to the surface of all upper slots through which the air flows.

In other words, if the sum of all air passing cross sections is called A and the external heat transfer surface of the slotted conductor is called B, then the ratio B/A should preferably be in the range of 70 to 100.

As it is clear from above, the invention also covers a solution wherein a single slot is made at the top and a single slot is made at the bottom of the conductor in front of the slot at the top. But tests have shown that this solution with only 2 single slots may result, if said single slots are too large, in a too strong concentration of the current around the slots and leads to increased Joule losses and temperature rises. Alternatives are therefore:
an embodiment comprising 2 slots made at the top and 2 slots made at the bottom of the conductor, preferably in front of the slots at the top (see FIG. 4A and FIGS. 9A and 9B);
an embodiment comprising 3 slots made at the top and 3 slots made at the bottom of the conductor, preferably in front of the slots at the top (see FIGS. 4B, 6A and 6B).

According to an aspect of the invention, the air flows by convection from the bottom of the casing, through the bottom slot(s) 32a, upwards through the conductor and then through the upper slot(s) 31a. The invention provides an efficient natural cooling of a conductor, while saving material. But the enclosure is heated by the heat transported by the air flows, therefore attention must also be paid to the temperature of the enclosure.

Only one phase is discussed above, but the application finds application for a 3 phases circuit breaker/disconnector, each one having a structure according to the invention.

The invention can for example find application in circuit breakers in which a very high nominal current circulates (for example 10 kA and 50 kA) and/or with a voltage range from 10 kV to 40 kV.

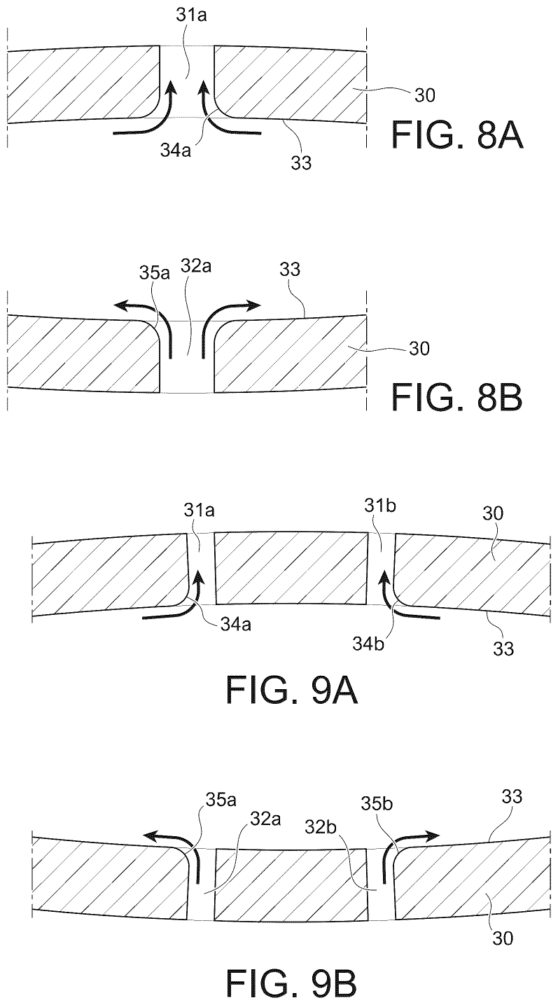

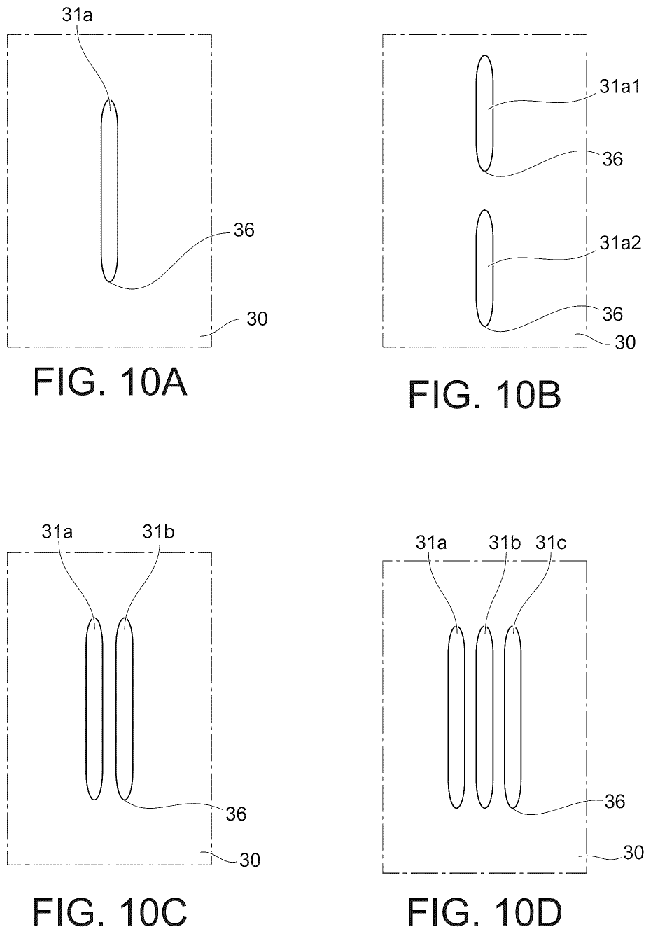

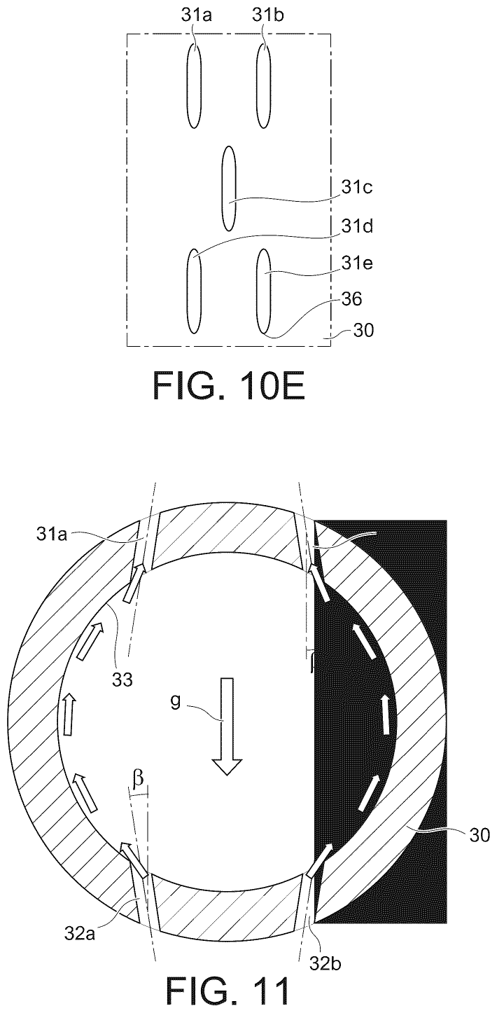

Another aspect of the invention is now described in connection with FIGS. 8A-11:
FIGS. 8A and 8B show cross sections in a radial direction of the disconnector for the configuration of one top slot and one bottom slot. FIG. 8A shows an enlarged view of the upper slot 31a and of rounded edges 34a at the inside surface 33 of the hollow conductor 30. FIG. 8B shows an enlarged view of the lower slot 32a and of rounded edges 35a at said inside surface 33 of the hollow conductor 30; the arrows on these figures show the fluid flow along said inside surface 33: clearly, the rounded edges 34a and 35a, at the inside of the hollow conductor are favorable to this fluid flow; since the skin effect concentrates the current at the outside of the conductor, shape optimization for a smoother fluid flow is preferably done only at the inside of the conductor, where a reduction of the electrical cross section is of less importance;
FIGS. 9A and 9B show cross sections in a radial direction of the disconnector for a configuration of two top slots 31a and 31b and two bottom slots 32a and 32b. FIG. 9A shows an enlarged view of the upper slots 31a and 31b and of rounded edges 34a and 34b at the inside of the hollow conductor 33. The rounding on the inside enables the fluid flow to move smoothly and with a low pressure drop around the corner. FIG. 9B shows an enlarged view of the lower slots 32a and 32b and of rounded edges 35a and 35b at the inside of the hollow conductor 30. The slot, and therefore the cooling air, is directed to the hot conductor surface; the same effect as described above in terms of favoriting the fluid flow along surface 33 is achieved; preferably, the rounded edges 35a, 35b are made only on the sides 33 along which the fluid should flow. The rounded edges 35a and 35b, have positive diffuser effect leading to a lower pressure drop and thus an easier passage of the air through the slot;
FIGS. 10A-10E show several cooling slot(s) configurations according to an embodiment of the invention, all slots 31a to 31c having rounded ends 36. All 5 figures show a view from the top of the enclosure onto the disconnector, but similar configurations can be applied to the bottom slots 32a to 32c. FIG. 10A (respectively 10C or 10D) shows 1 (respectively 2 or 3) slot 31a (respectively 31a and 31b or 31a, 31b and 31c) being symmetrically positioned from the vertical plane comprising the axis XX′ of the hollow tube; FIG. 10E shows a configuration comprising 2 double slots 31a, 31b, a single slot 31c, and another double slot 31d and 31e. In all configurations, the rounded ends 36, enable a smooth current path without local current concentrations. As illustrated on FIG. 10B, a single cooling slot can also be splitted into to two or more aligned cooling slots which can have rounded and/or oval ends 36 having the same beneficial effect on temperature rise. For mechanical stability reasons one or more of the top and bottom slots 31a1, 31a2 (see FIG. 10B) can be divided in 2, 3 or even more (for example 10) slots aligned in axial direction as in the example shown on FIG. 10B, on which the slots are aligned but divided into two slots. The small bridge of conductive material between them increases the strength and rigidity of the overall conductor structure considerably.

The present invention implements natural convection of a natural fluid moving from the hot live parts to the cold enclosure and which carries calories away. For high permanent currents, for example in the range of 10 to 30 kA, natural cooling is sufficient to keep temperatures of live parts below limits. No extra cooling means like fans or heat pipes are needed. Improving and optimizing natural convection helps to cool down the equipment more efficiently and allows the user in the aftermath to use the same product for even higher nominal currents without extra investment.

The present invention deals with the optimized cooling of the special equipment of air insulated generator circuit breakers and disconnectors located in an enclosure. In depth analysis of positioning, shape and dimensioning of cooling slots results in considerable performance increase while saving conductive material at the same time.

The inventors of the present invention have simulated different configurations and have come to different features of cooling slots to reduce temperature rise while saving conductive material at the same time. These features are the design and/or position and/or shape and/or width and/or length of the cooling slots.

As shown on FIGS. 5A and 5B, in a device comprising only one slot at the top and one slot at the bottom, the 2 slots should preferably be facing each other. In a configuration comprising more than one slot at the top and/or more than one slot at the bottom a symmetric design should be preferred, see for example FIGS. 4A and 4B. The angle shown in FIGS. 4A and 4B should be kept above 10° and below 80° (see results in FIG. 7C).

As shown on FIG. 11, the slots, in this example 2 bottom and 2 upper slots are preferably oriented differently to obtain better results:
on the lower side, slots 32a and 32b are preferably diverging from each other (from the outside to the inside of the conductor 30) and oriented so that cold cooling air flow can be directed to or along the hot inner disconnector surface 33; indeed cold air coming through the slot has considerable kinetic energy which is used to exchange heat efficiently with the disconnector's inside surface. The slots may be directed to the inside surface with an angle β comprised in a range of 5 to 30 degrees compared the vertical direction;
on the upper side slots 31a and 31b are preferably converging to each other (from the inside to the outside of the conductor 30) and are preferably oriented so as to be as less resistant as possible for the heated air flow to leave the hollow inner part of the disconnector. Therefore the slots are directed in a way that the air flow needs to turn the least. The slots may be directed to the inside surface with an angle β comprised in a range of 5 to 30° compared to the vertical direction.

FIGS. 7A-7C show the temperature rise for different design parameters and/or different devices (having different diameters), different slots widths, and/or different number of slots, and/or different angles between neighbouring slots.

The upper part of FIG. 7A illustrates the maximum temperature rise for devices having identical diameters and geometries. The maximum temperature rise is indicated on top of each diagram and varies between 70.3 Kelvin and 72.9 Kelvin.

The 1st device (on the left, temperature rise 72.9 Kelvin) has no slot and each of the other devices has 1 slot at the top and 1 slot at the bottom, said slots having different widths, 5 mm, 10 mm, 15 mm, 20 mm, 30 mm, 40 mm (from left to right).

The lower part of FIG. 7A illustrates the material consumption for the same devices arranged in the same order as on the upper part of FIG. 7A, starting from the left with the device with no slot (100% material). Integrating or adding wider and wider slots leads to lower conductive material consumption.

The upper part of FIG. 7B illustrates the maximum temperature rise for 20 different numbers of slots and for identical device diameters and for identical air flow cross section (except device 1 which as no slot, thus a cross section of 0). The maximum temperature rise is indicated on top of each diagram and varies between 69.8 Kelvin and 72.9 Kelvin.

The 1st device (on the left, maximum temperature rise 72.9 Kelvin) has no slot; the next device to the right has 1 slot at the top and 1 slot at the bottom (device maximum temperature rise 70.3 Kelvin, each slot having a width of 20 mm), the next device to the right has 2 slots at the top and 2 slot at the bottom (device temperature rise 70.0 Kelvin, each slot having a width of 10 mm), and the last on the right has 3 slots at the top and 3 slot at the bottom (device maximum temperature rise 69.8 Kelvin, each slot having a width of 6.7 mm).

The lower part of FIG. 7B illustrates the material consumption for the same devices arranged in the same order as on the upper part of FIG. 7B, starting from the left with the device with no slot (100% material), the other 3 devices consuming the same amount of aluminium (98.6%), the outer diameter being identical for all 4 devices.

The upper part of FIG. 7C illustrates the maximum temperature rise for different angles α between neighbouring slots for identical device diameters. The maximum temperature rise is indicated on top of each diagram and varies between 69.8 Kelvin and 72.9 Kelvin.

The 1st device (on the left, maximum temperature rise 72.9 Kelvin) has no slot. The other devices have 2 slots at the top and 2 slots at the bottom and are separated respectively by an angle of 10° (device having a maximum temperature rise 70.0 Kelvin), of 20° (device having a maximum temperature rise 69.8 Kelvin), of 30° (device having a maximum temperature rise 69.9 Kelvin), of 40° (device having a maximum temperature rise 69.8 Kelvin), of 60° (device having a maximum temperature rise 69.9 Kelvin), of 80° (device having a maximum temperature rise 70.2 Kelvin), of 100° (device having a maximum temperature rise 70.7 Kelvin).

Preferably, the angle α between neighbouring slots is between 20° and 60°.

The lower part of FIG. 7C illustrates the material consumption starting for the same devices arranged in the same order as on the upper part of FIG. 7C, starting from the left with the device with no slot (100% material), the other devices consuming the same amount of aluminium (98.6%).

The FIGS. 7A-7C show that the invention allows a reduction of the temperature rise of some Kelvin, for example from 72.9 Kelvin down to 69.8 Kelvin, a temperature reduction of more than 4%, while saving 1.4% of conductive material at the same time. This allows a higher current to circulate: with an estimated 4% less heating (due to the presence of the slots) it is possible to increase the rated current by around 4% while still limiting the temperature rise to 75 Kelvin. For example a device with a maximum current of 20 kA (without slots) can be used up to 20.8 kA with cooling slots according to the invention.

Keeping the highest temperature rise of the conductor bellow 75 Kelvin allows saving cooling fans, which otherwise must be implemented around the conductor.

The invention allows a reduction of the maximum or hot spot temperature which allows an optimization of the equipment and a higher nominal current without increasing the conductive cross section.

I claim:

1. A high voltage circuit breaker and disconnector for operation in air, extending along an axis, comprising an enclosure, the disconnector comprising a hollow current carrying conductor in the enclosure and extending along the axis, the conductor comprising at least one lower elongated slot and at least one upper elongated slot extending along the axis, each slot having a width w and a length l, the product of l and w giving an air flow cross section of each slot, the ratio between the outer diameter surface of the hollow current carrying conductor and the total air flow cross sections of all the slots being between 70 and 100.

2. The high voltage circuit breaker/disconnector as in claim 1, whereby:
the conductor comprises at least 1, 2, 3, or more lower slot(s) and a same or different number of upper slot(s), the lower slot(s) and the upper slot(s) facing each other;
and/or at least one of the upper and/or the lower slots is divided into several aligned slots.

3. The high voltage circuit breaker/disconnector as in claim 2, comprising two or more lower slots and two or more upper slots:
each of the slots of the upper part being separated by an angle of between 20° and 60° to a neighbouring slot;
and/or each of the slots of the lower slots being separated by an angle of between 20° and 60° to a neighbouring slot.

4. The high voltage circuit breaker/disconnector as in claim 3:
the slots of the upper slots being separated by an angle of 10°;
and/or the slots of the lower slots being separated by an angle of 10°.

5. The high voltage circuit breaker/disconnector as in claim 1, the width of each slot being between 5 mm and 40 mm.

6. The high voltage circuit breaker/disconnector as in claim 1, wherein the surface of the one or more lower slots through which the air flows into the hollow conductor being identical or similar, in a range of 5%, to the surface of the one or more upper slots through which the air flows out of the hollow conductor.

7. The high voltage circuit breaker/disconnector as in claim 1, the hollow current carrying conductor having an outer diameter between 30 cm and 200 cm.

8. The high voltage circuit breaker/disconnector as in claim 1, wherein the slots are oriented towards an inner surface of the disconnector.

9. The high voltage circuit breaker/disconnector as in claim 1, wherein at least one of the slots has at least one rounded edge at the inside of the hollow conductor in a curvilinear direction from the axis.

10. The high voltage circuit breaker/disconnector as in claim 1, wherein at least one of the slots has at least one rounded or oval edge at the inside of the hollow conductor in a direction parallel to the axis.

11. The high voltage circuit breaker/disconnector as in claim 1, wherein the enclosure is filled with air.

12. The high voltage circuit breaker/disconnector as in claim 1, wherein one or more bottom slot(s) and/or upper slot(s) are directed to the inside surface with an angle of 5 to 30°.

13. A three phases circuit breaker/disconnector, each phase comprising a high voltage circuit breaker/disconnector as in claim 1.

14. A method for cooling a circuit breaker and disconnector according to claim 1, operating in air, a current of between 10 kA and 50 kA circulating in the conductor, whereby air is circulating from the least one lower slot to the at least one upper slot.

15. A method according to claim 14, whereby air is circulating from the least one lower slot to the inner surface of the conductor and then to the at least one upper slot driven by natural convection.
